(19) United States
(12) Patent Application Publication
(10) Pub. No.: US 2026/0358458 A1
(43) Pub. Date: Nov. 12, 2026

(54) POSITIONING METHOD AND DEVICE IN WIRELESS COMMUNICATION SYSTEM

(71) Applicant: Samsung Electronics Co., Ltd., Suwon-si, Gyeonggi-do (KR)

(72) Inventors: Cheolkyu SHIN, Suwon-si (KR); Hyunsuk RYU, Suwon-si (KR); Kyoungmin PARK, Suwon-si (KR); Sungjin PARK, Suwon-si (KR); Kyunggyu LEE, Suwon-si (KR)

(21) Appl. No.: 19/469,925

(22) PCT Filed: Mar. 27, 2024
(86) PCT No.: PCT/KR2024/003875

§ 371 Date: Sep. 26, 2025

(30) Foreign Application Priority Data
Mar. 31, 2023 (KR) 10-2023-0043037

(51) Int. Cl. G01S 5/00; G01S 5/02

(52) U.S. Cl. CPC G01S 5/0018; G01S 5/021

(57) ABSTRACT

The present disclosure relates to a 5G or 6G communication system to support a higher data transmission rate. The present disclosure relates to a wireless mobile communication system and particularly to a method and device for compensating for positioning errors that may occur when a signal is transmitted through a repeater.

### TECHNICAL FIELD

The disclosure relates to a wireless communication system and, particularly, to a method and a device for compensating for a positioning (location measurement) error that may occur when a signal is transmitted through a repeater.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Moreover, in order to provide stable coverage, a study is being made of communication schemes using a repeater that performs operations of receiving and amplifying signals transmitted by a base station.

### DISCLOSURE

### Technical Problem

The disclosure relates to a wireless communication system and, particularly, to a method and a device for compensating for a positioning (location measurement) error that may occur when a signal is transmitted through a repeater. Specifically, an internal delay time that occurs during signal reception and transmission by a repeater may be a factor that hinders achieving high accuracy when positioning methods of measuring a time at which a signal is actually transmitted are used. Furthermore, when angle-based positioning methods are used due to a repeater, an error may occur at a measured position. The disclosure proposes a method and device capable of solving these issues.

### Technical Solution

The disclosure for solving the issues above relates to a method performed by a terminal in a communication system, the method including: receiving repeater-related information for positioning from a base station; and identifying a location of the terminal, based on the repeater-related information, wherein the location of the terminal is corrected based on the repeater-related information, and the repeater-related information is transmitted from a repeater to the base station.

In addition, a method performed by a base station in a communication system includes: receiving repeater-related information for positioning from a repeater; and transmitting the received repeater-related information to a terminal, wherein a location of the terminal is identified by the terminal, and the location of the terminal is corrected based on the repeater-related information.

In addition, a terminal in a communication system includes: a transceiver; and a controller configured to receive repeater-related information for positioning from a base station, and identify a location of the terminal, based on the repeater-related information, wherein the location of the terminal is corrected based on the repeater-related information, and the repeater-related information is transmitted from a repeater to the base station.

In addition, a base station in a communication system includes: a transceiver; and a controller configured to receive repeater-related information for positioning from a repeater, and transmit the received repeater-related information to a terminal, wherein a location of the terminal is identified by the terminal, and the location of the terminal is corrected based on the repeater-related information.

### Advantageous Effects

The disclosure is to propose a method and a procedure for performing positioning in an environment where a repeater is used. Through the proposed method, accurate positioning may be possible even in an environment with a repeater.

### DESCRIPTION OF DRAWINGS

FIG. 1 is a diagram illustrating an example of a system according to an embodiment of the disclosure.

FIG. 2 is a diagram illustrating an example of an NCR according to an embodiment of the disclosure.

FIG. 3 is a diagram illustrating an example of a positioning procedure in Uu according to an embodiment of the disclosure.

FIG. 4 is a diagram illustrating an example of a positioning procedure in SL according to an embodiment of the disclosure.

FIG. 5 is a diagram for describing a timing error and a TEG when a repeater is not considered, according to an embodiment of the disclosure.

FIG. 6 is a diagram for describing a timing error and a TEG when a repeater is considered, according to an embodiment of the disclosure.

FIG. 7A is a diagram illustrating an example of the influence of a positioning method via angle measurement when a repeater is considered, according to an embodiment of the disclosure.

FIG. 7B is a diagram illustrating another example of the influence of a positioning method via angle measurement when a repeater is considered, according to an embodiment of the disclosure.

FIG. 8A is a diagram illustrating an example of a method for solving, via base station implementation, a problem in which an error occurs in time-based positioning measurement due to a repeater, according to an embodiment of the disclosure.

FIG. 8B is a diagram illustrating an example of a method for a base station to determine whether a signal transmitted from a terminal is received through a repeater.

FIG. 9A is a diagram illustrating an example of a method capable of resolving, via standard support, a problem in which an error occurs in time- and angle-based positioning measurement due to a repeater, according to an embodiment of the disclosure.

FIG. 9B is a diagram illustrating a more detailed example of a method of supporting a positioning method when a repeater is an NCR.

FIG. 10 is a diagram illustrating an example of a dedicated resource for requesting positioning-related information.

FIG. 11 illustrates an internal structure of a UE according to an embodiment of the disclosure.

FIG. 12 illustrates an internal structure of a base station according to an embodiment of the disclosure.

### MODE FOR INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

The following detailed description of embodiments of the disclosure is mainly directed to New RAN (NR) as a radio access network and Packet Core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the 5G system, a network data collection and analysis function (NWDAF), which is a network function for analyzing and providing data collected in a 5G network, may be defined to support network automation. The NWDAF may collect/store/analyze information from the 5G network and provide the results to unspecified network functions (NFs), and the analysis results may be used independently in each NF.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

Various services to be provided in 5G communication systems are being studied, and one of them is a service that satisfies requirements for low latency and high reliability. Furthermore, demands for mobile services are explosively increasing, and location-based services (LBSs) led by two requirements, that is, emergency services and commercial applications, are rapidly growing.

In particular, a repeater may serve to forward a signal received from a transmission end so that the signal can be better transmitted to a reception end. The transmission end may transmit a positioning signal for positioning (location measurement), and this signal may also be forwarded through the repeater. However, an internal delay may occur during signal reception and retransmission by the repeater. An internal delay occurring in a repeater may vary depending on the repeater, but may be a value corresponding to several tens of ns. Specifically, an internal delay of 50 ns may be converted to a distance equivalent to 15 meters when considering the speed of light. Accordingly, when time-based positioning is performed, an internal delay occurring in a repeater may have a significant impact on accuracy of positioning. In other words, when a positioning signal is received through a repeater, positioning accuracy may be degraded due to an internal delay of the repeater.

Furthermore, an error may occur in a position measured by angle-based positioning methods due to a repeater. Specifically, angle measurement, such as an angle of arrival (AoA) or an angle of departure (AoD) between a base station and a UE, may be erroneously performed as angle measurement between the base station and the repeater or between the repeater and the UE due to forwarding of a positioning signal by the repeater.

The disclosure proposes methods to solve these issues. When the methods proposed in the disclosure are used, it may be possible that not only a positioning signal through a repeater is transmitted to have wide coverage, but also high positioning accuracy is maintained.

Embodiments of the specification are proposed to support the aforementioned scenario and, in particular, are to provide a method and a device for measuring a location (positioning) of a UE in an environment where a repeater is used.

For positioning of a UE, a positioning signal is transmitted, and positioning measurement may be performed based on the signal. A positioning signal transmitted by a base station to a UE may be referred to as a downlink positioning reference signal (DL-PRS). A positioning signal transmitted by a UE to a base station may be referred to as a sounding reference signal (SRS). A positioning signal transmitted between UEs may be referred to as a sidelink positioning reference signal (SL-PRS).

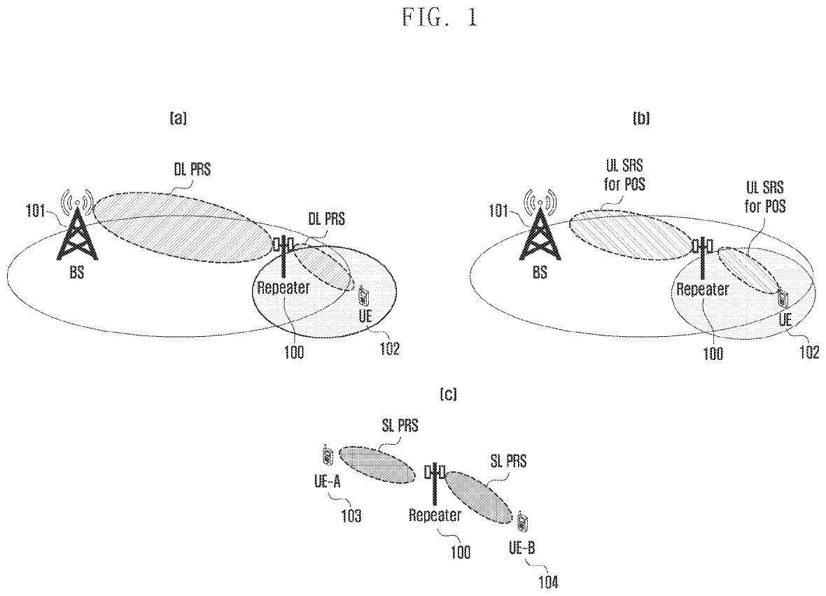

FIG. 1 is a diagram illustrating an example of a system according to an embodiment of the disclosure. According to FIG. 1, cases in which signals are forwarded through a repeater 100 during downlink (DL), uplink (UL), and sidelink (SL) transmission are illustrated.

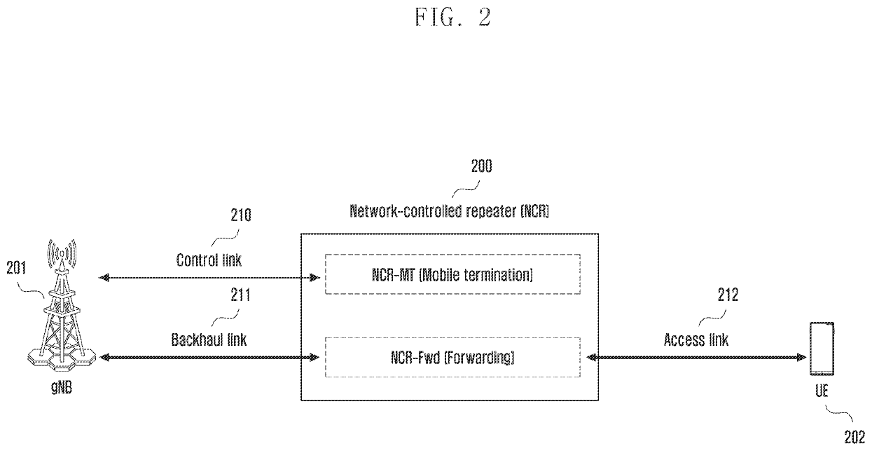

Various types of repeaters 100 may be considered in the disclosure. For example, a general radio frequency (RF) repeater may be considered. An RF repeater may only serve to forward a received signal during signal reception and retransmission by the repeater. In other words, this corresponds to a case in which the repeater does not decode or reprocess the received signal. This case has an advantage of very simple implementation of the repeater. However, a repeater that decodes or reprocesses a received signal may also be considered. As another example, a network-controlled repeater (NCR) may be considered. For details on an NCR, reference is made to FIG. 2. In addition, a UE typically cannot identify whether a signal has been forwarded by a repeater. However, in the disclosure, a case where a UE is able to identify whether a signal has been forwarded by a repeater is also considered.

It is advantageous that a repeater retransmits a received signal so that the signal can be better transmitted to a reception end. However, an internal delay time and/or angle measurement error may occur during signal reception and retransmission at a repeater. If a signal received by a repeater is a positioning signal, an internal delay time may be critical to positioning measurement. This is because, when positioning methods of location measurement using an actual signal transmission time are used, an internal delay time of a repeater may be reflected as an error. In addition, an angle between a base station and a UE, which should be measured, may be incorrectly measured as an angle between the base station and a repeater or an angle between the repeater and the UE. This may hinder achievement of high positioning accuracy.

Referring to FIG. 1A, illustrated is an example in which a base station 101 transmits a DL signal to a UE 102 through the repeater 100. As illustrated in FIG. 1A, the base station 101 may transmit a DL-PRS signal as the DL signal. The UE 102 having received the DL PRS through the repeater 100 may perform positioning measurement and positioning-related calculation via the DL PRS.

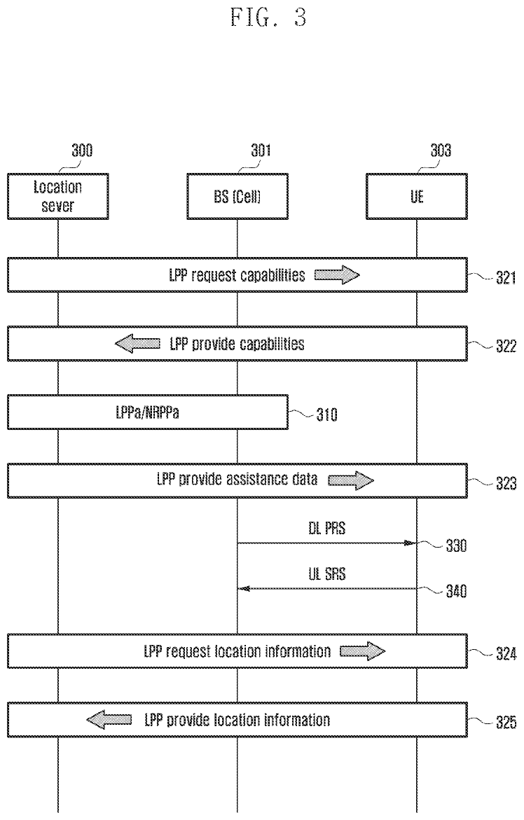

Referring to FIG. 1B, illustrated is a case in which the UE 102 transmits a UL signal to the base station 101 through the repeater 100. As illustrated in FIG. 1B, the UE 102 may transmit, as the UL signal, an SRS for positioning measurement. The base station 101 having received the UL SRS through the repeater 100 may perform positioning measurement via the SRS. The base station 101 may forward positioning measurement information to a location server connected to the base station, and the location server may perform positioning-related calculation. For descriptions of this procedure, reference is made to FIG. 3.

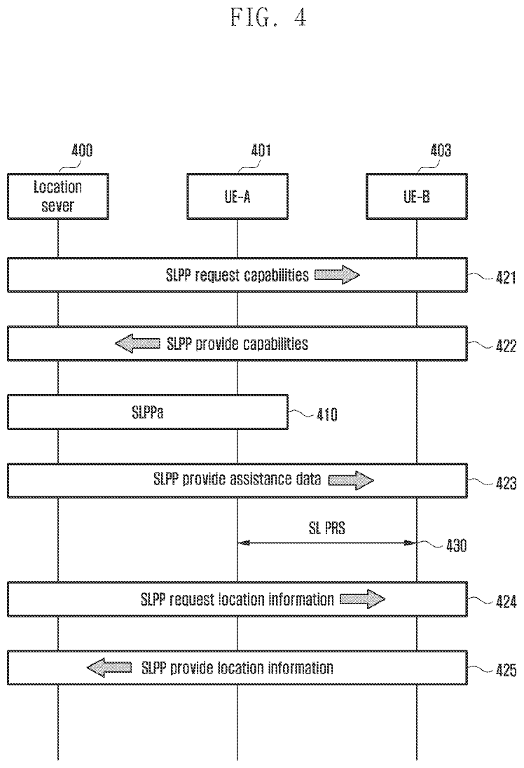

Referring to FIG. 1C, illustrated is a case in which a UE 103 transmits an SL signal to another UE 104 through the repeater 100. As illustrated in FIG. 1C, the UE 103 may transmit, as the SL signal, an SL PRS for positioning measurement. The UE 104 having received the SL SRS through the repeater 100 may perform positioning measurement and positioning-related calculation via the SL PRS. Alternatively/additionally, the UE 104 may forward positioning measurement information to the location server connected to the base station and the UE, and the location server may perform positioning-related calculation. For detailed descriptions on this, reference is made to descriptions related to FIG. 3 and FIG. 4.

FIG. 2 is a diagram illustrating an example of an NCR according to an embodiment of the disclosure.

Referring to FIG. 2, illustrated is an example in which a repeater 200 exists between a base station 201 and a UE 202, so that a DL signal or a UL signal may be forwarded through the repeater. Unlike a general RF repeater, an NCR repeater is advantageous in that the base station 201 and the repeater 200 are connected via a control link (hereinafter, interchangeably used with C-link) so as to enable network control. Various information for controlling the repeater 200 may be exchanged between the base station 201 and the repeater 200 via the C-link. In addition, a backhaul link 211 may be assumed to be a wireless link via which signals are transmitted and received between the base station 201 and the repeater 200. In addition, an access link 212 may be assumed to be a wireless link via which signals are transmitted and received between the repeater 200 and the UE 202.

In the disclosure, information exchanged via the C-link is not limited to specific information. For example, beam-related information may be exchanged via the C-link, and when the related information is exchanged, the repeater 200 may use beam information when forwarding, to the UE 202, a signal received from the base station 201, so that the signal is forwarded in the direction of the UE 202. This may be particularly useful when signal transmission via beamforming is essential in a high-frequency band, such as frequency range2 (FR2). Information additionally required to control the repeater 200 via the C-link according to the disclosure will be proposed via the following embodiments.

Hereinafter, as a positioning method of measuring a location of the UE, a method using a positioning signal transmitted via a downlink and an uplink of the UE and the base station will be described. In the disclosure, a method using a positioning signal transmitted via a downlink and an uplink of a UE and a base station may be referred to as radio access technology (RAT)-dependent positioning. In addition, other positioning methods may be classified as RAT-independent positioning. Specifically, for an LTE system, methods, such as observed time difference of arrival (OTDOA), uplink time difference of arrival (UTDOA), and enhanced cell identification (E-CID), may be used as an RAT-dependent positioning technique. For an NR system, methods, such as downlink time difference of arrival (DL-TDOA), downlink angle-of-departure (DL-AOD), multi-round trip time (multi-RTT), NR E-CID, uplink time difference of arrival (UL-TDOA), or uplink angle-of-arrival (UL-AOA), may be included. In contrast, an RAT-independent positioning technique may include methods using, for example, assisted global navigation satellite systems (A-GNSS), a sensor, wireless local area network (WLAN), or Bluetooth.

For RAT-dependent positioning in an interface (uplink and downlink, hereinafter, referred to as Uu) between a base station and UEs, positioning protocols, such as LTE positioning protocol (LPP), LTE positioning protocol annex (LPPa), and NR positioning protocol annex (NRPPa), may be used. First, LPP is a positioning protocol defined between a UE and a location server (LS), and LPPa and NRPPa may be considered as protocols defined between a base station and a location server. Here, the location server is a subject that manages location measurement, and may perform functions of a location management function (LMF). In addition, the location server may also be referred to as LMF or another name. Both LTE and NR systems support LPP, and at least one of the following functions for positioning may be performed via LPP.
Positioning capability exchange
Assistance data transmission
Location information transmission
Error handling
Abort

When a UE and a location server perform the functions above via LPP, a base station may function to enable the UE and the location server to exchange positioning information. In this case, exchanging of the positioning information via LPP may be performed transparently to the base station. This may indicate that the base station is not involved in exchanging of the positioning information between the UE and the location server.

For the positioning capability exchange, the UE may exchange, with the location server, positioning information supportable by the UE. For example, the positioning information supportable by the UE may include whether a positioning method supported by the UE is a UE-assisted method or a UE-based method, or whether both of the methods are supportable. Here, the UE-assisted method refers to a scheme in which the UE does not directly measure an absolute position of the UE and forwards only a measurement value according to a positioning technique applied based on a received positioning signal, wherein the absolute position of the UE is calculated by the location server. Here, the absolute position may represent two-dimensional (x, y) and three-dimensional (x, y, z) coordinate location information of the UE according to longitude and latitude. In contrast, the UE-based method may be a scheme in which the UE directly measures an absolute position of the UE, and to this end, while receiving a positioning signal, the UE also needs to receive location information of a subject that transmits the positioning signal. While the LTE system supports only the UE-assisted scheme, the NR system may support positioning based on both the UE-assisted and UE-based schemes.

Subsequently, assistance data transmission may be a very important element in measuring an accurate location of the UE. Specifically, for assistance data transmission, the location server may provide the UE with configuration information for a positioning signal, information on a candidate cell and a transmission reception point (TRP) for reception of the positioning signal, etc. Specifically, when DL-TDOA is used, information on a candidate cell and a TRP for reception of a positioning signal may include information on a reference cell and a reference TRP, information on a neighbor cell and a neighbor TRP, etc. In this case, multiple candidates for the neighbor cell and the neighbor TRP are provided, and information on which cell and TRP the UE should select to measure a positioning signal may also be provided.

In order for the UE to measure an accurate location, it is required to properly select candidate cell and TRP information serving as a reference. For example, the accuracy of positioning measurement may be increased when a channel for a positioning signal received from a corresponding candidate cell and TRP is a line-of-site (LOS) channel, in other words, a channel having fewer non-LOS (NLOS) channel components. Therefore, when the location server provides the UE with candidate cell and TRP information, which serves as a reference for performing positioning, via various information collection, the UE may perform more accurate positioning.

Subsequently, location information transmission may be performed via LPP. The location server may request location information from the UE, and the UE may provide the location server with the measured location information in response to the request. For the UE-assisted method, the location information may be a measurement value according to a positioning technique applied based on a positioning signal received by the UE. In contrast, for the UE-based method, the location information may be two-dimensional (x, y) and three-dimensional (x, y, z) coordinate location values of the UE. When requesting the location information from the UE, the location server may make the request including a required accuracy, response time, etc. as positioning quality of service (QoS) information. The UE having received the positioning QoS information needs to provide the location server with location information measured to satisfy the accuracy and response time, and if it is impossible to satisfy the QoS, the UE may consider error handling and abort. However, this is merely an example, and error handling and abort for positioning may also be performed in a case other than a case where it is impossible to satisfy the QoS.

Subsequently, the positioning protocol defined between the base station and the location server may be referred to as LPPa in the LTE system, and at least one of the following functions may be performed between the base station and the location server via LPPa.
E-CID location information transmission
OTDOA information transmission
General error state reporting
Assistance information transmission

In addition, the positioning protocol defined between the base station and the location server may be referred to as NRPPa in the NR system, and in addition to the above functions performed by LPPa, at least one of the following functions may be performed between the base station and the location server via NRPPa.
Positioning information transmission
Measurement information transmission
TRP information transmission

Unlike the LTE system, the NR system supports more positioning techniques. Therefore, via the positioning information transmission, various positioning techniques may be supported. For example, it is possible for the base station to perform positioning measurement based on a positioning SRS transmitted by the UE. Therefore, as positioning information, information on configuration and activation or deactivation of the positioning SRS may be exchanged between the base station and the location server.

Subsequently, measurement information transmission refers to a function of exchanging, between the base station and the location server, information on multi-RTT, UL-TDOA, and UL-AOA which are not supported in the LTE system. Finally, cell-based positioning has been performed in the LTE system, but TRP-based positioning may be performed in the NR system, so that TRP information transmission refers to a function of exchanging information on performing TRP-based positioning.

The disclosure also considers an RAT-dependent positioning method supported via a sidelink (SL). RAT-dependent positioning in Uu is possible only when a UE is within coverage of a base station. If a UE performs communication using SL within coverage of a base station, a positioning protocol defined in Uu may be used, and positioning may be performed via a location server. However, RAT-dependent positioning of SL may be possible even when the UE is outside the coverage of the base station. In this case, an SL location server and an SL positioning protocol may be defined. This protocol may be referred to as, for example, sidelink positioning protocol (SLPP). Unlike in Uu, a UE connected to a location server may exist in SLPP, and roles of an SL location server and a positioning protocol may be similar to those of the Uu.

FIG. 3 is a diagram illustrating an example of a positioning procedure in Uu according to an embodiment of the disclosure.

Referring to FIG. 3, a location server 300 may request 321 UE capability from a UE 303 via LPP. The UE 303 may provide 322 supportable positioning information to the location server. For example, the supportable positioning information may include whether a positioning method supported by the UE is a UE-assisted method or a UE-based method, or whether both of the methods are supportable.

In addition, the location server 300 and a base station 301 may exchange, via LPPa or NRPPa 310, information required for positioning. For details on this, reference may be made to the information exchange function between the base station and the location server via LPPa or NRPPa. For example, the base station 301 may provide the location server 300 with positioning measurement information based on a UL SRS 340 received from the UE. Furthermore, the base station may transmit TX timing error group (TEG) information or RX TEG information of the base station 301. For details on this, reference is made to FIG. S.

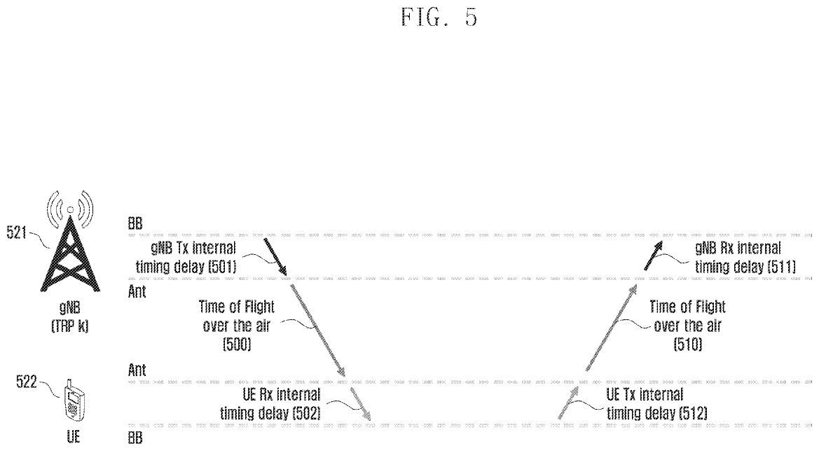

Subsequently, the location server 300 may transmit 323 assistance data to the UE 303 via LPP. For details on this, reference is made to the LPP functions. For example, the assistance data may include configuration information of a positioning signal, so that base station 301 may transmit a DL PRS 330 to the UE 303, or the UE 303 may transmit the UL SRS 340 for positioning to base station 301. Subsequently, the location server 300 may request 324 location information from the UE 303 via LPP. Then, the UE 303 may provide 325 the location information via LPP. The location information provided by the UE in operation 325 may be positioning measurement information based on the DL PRS 330 in the case of the UE-assisted scheme. In contrast, the location information provided by the UE in operation 325 may be coordinate location information calculated by the UE in the case of the UE-based scheme. The UE may transmit not only the location information but also the RX TEG information of the UE in operation 325. For details on this, reference is made to FIG. 5.

FIG. 4 is a diagram illustrating an example of a positioning procedure in SL according to an embodiment of the disclosure.

Referring to FIG. 4, a location server 400 may request 421 UE capability via SLPP from UE B 403 which performs positioning measurement and calculation. SLPP is a positioning protocol which enables execution of functions similar or identical to the functions of LPP described above, but is defined for positioning of a UE located outside base station coverage in SL, and may be referred to as a different name. UE B 403 may provide 422 supportable positioning information to the location server 400. For example, the positioning information supportable by the UE may include whether a positioning method supported by the UE is a UE-assisted method or a UE-based method, or whether both of the methods are supportable. If the UE is within coverage of a base station, the location server 400 may be connected to the base station. In contrast, if the UE is outside the coverage of the base station, the location server 400 may be connected to the UE. Alternatively, if the UE is outside the coverage of the base station, a server UE may be defined. Here, the server UE refers to a UE that serves as a location server, and both UE A 401 serving as an anchor UE and UE B 403 that is a target UE may be server UEs. In sidelink positioning, an anchor UE may refer to a UE that provides a positioning signal and a related indication to a target UE that performs positioning.

In addition, the server UE may exchange information required for positioning with the location server via a sidelink positioning protocol annex (SLPPa). SLPPa is a positioning protocol which enables execution of functions similar or identical to the functions of LPPa or NRPPa described above, but is defined for positioning of a UE located outside base station coverage in SL, and may be referred to as a different name. In addition, SLPPa may not be defined. For example, UE A 401 may provide, to the location server 400 connected to UE A 401, positioning measurement information based on an SL PRS 440 received from UE B 401. Furthermore, UE A 401 may transmit TX TEG information or RX TEG information of UE A 401. For details on this, reference is made to FIG. 5 (in this case, in FIG. 5, the base station may be replaced with UE A 401, and the UE may be replaced with UE B 403).

Subsequently, the location server 400 may transmit 423 assistance data to UE B 403 via SLPP. For example, the assistance data may include configuration information of a positioning signal, so that UE A 401 may transmit the SL PRS 330 to UE B 403, or UE B 403 may transmit the SL PRS 330 for positioning to UE A 401. Subsequently, the location server 400 may request 424 location information from UE B 403 via SLPP. Then, UE B 403 may provide 425 the location information via SLPP. The location information provided by the UE in operation 425 may be positioning measurement information based on the SL PRS 330 in the case of the UE-assisted scheme, and may be coordinate location information calculated by the UE in the case of the UE-based scheme. UE B 403 may transmit, in operation 425, not only the location information but also TX TEG information or RX TEG information of UE B 403. For details on this, reference is made to FIG. 5 (in this case, in FIG. 5, the base station may be replaced with UE A 401, and the UE may be replaced with UE B 403).

FIG. 5 is a diagram for describing a timing error and a TEG when a repeater is not considered, according to an embodiment of the disclosure. TEG may be defined as follows.
The TEG is associated positioning measurement(s) or resource(s) which has the timing error difference within a certain margin.

Referring to FIG. 5, consideration is given to a positioning method in which, when a base station 521 transmits a positioning signal to a UE 522, the UE 522 measures a time at which the signal has been transmitted. The equation below represents a time at which a positioning signal measured by the UE has been transmitted, when the positioning signal has been transmitted by the base station 521 (or which may be used interchangeably with TRP k) and received by the UE 522.

t_{UE-measurement}=t_{k-UE(TOF)}+e_{delay} [Equation 1]

In the equation above, t_{k-UE(TOF)} corresponds to 500 in FIG. 5, and denotes a time (time of flight (ToF)) at which the signal has actually been transmitted from the base station or TRP k 521 to the UE 522. e_{delay} denotes a timing error value, and a corresponding error may occur due to 501 and 502. Specifically, 501 is an internal delay that occurs when the base station 521 transmits a positioning signal, and may correspond to a delay time occurring from a point in time when the signal is generated in a baseband (BB) to a point in time when the RF signal is transmitted through an antenna. In addition, 502 is an internal delay that occurs when the UE 522 receives the positioning signal, and may correspond to a delay time occurring when the RF signal received through an antenna reaches a baseband (BB) and is time-stamped. The base station 521 may provide, as TX TEG, an internal delay value (or a remaining delay time after correction) of the base station and TRP to a location server, the internal delay value corresponding to 501. In addition, the UE 522 may provide, as RX TEG, an internal delay value (or a remaining delay time after correction) of the UE to the location server, the internal delay value corresponding to 502.

In addition, referring to FIG. 5, consideration is given to a positioning method in which, when the UE 522 transmits a positioning signal to the base station 521, the base station 521 measures a time at which the signal has been transmitted. The equation below represents a time at which a positioning signal measured by the base station has been transmitted, when the positioning signal has been transmitted by the UE 522 and received by the base station 521.

t_{BS-measurement}=t_{UE-k(TOF)}+e_{delay} [Equation 2]

In the equation above, t_{UE-k(TOF)} corresponds to 510 in FIG. 5, and denotes a time (ToF) at which the signal has actually been transmitted from the UE 522 to the base station or TRP k 521. e_{delay} denotes a timing error value, and a corresponding error may occur due to 512 and 511. Specifically, 512 is an internal delay that occurs when the UE 522 transmits a positioning signal, and may correspond to a delay time occurring from a point in time when the signal is generated in the baseband (BB) to a point in time when the RF signal is transmitted through the antenna. In addition, 511 is an internal delay that occurs when the base station 521 receives the positioning signal, and may correspond to a delay time occurring when the RF signal received through the antenna reaches the baseband (BB) and is time-stamped. The UE 522 may provide, as TX TEG, a value (or a remaining delay time after correction) corresponding to 512 to the location server. In addition, the base station 521 may provide, as RX TEG, an internal delay value (or a remaining delay time after correction) of the base station or TRP to the location server, the internal delay value corresponding to 511.

The errors in measuring the internal delay times occurring during DL and UL transmission presented in FIG. 5 may also occur in the same manner when positioning is performed via SL if a repeater is considered.

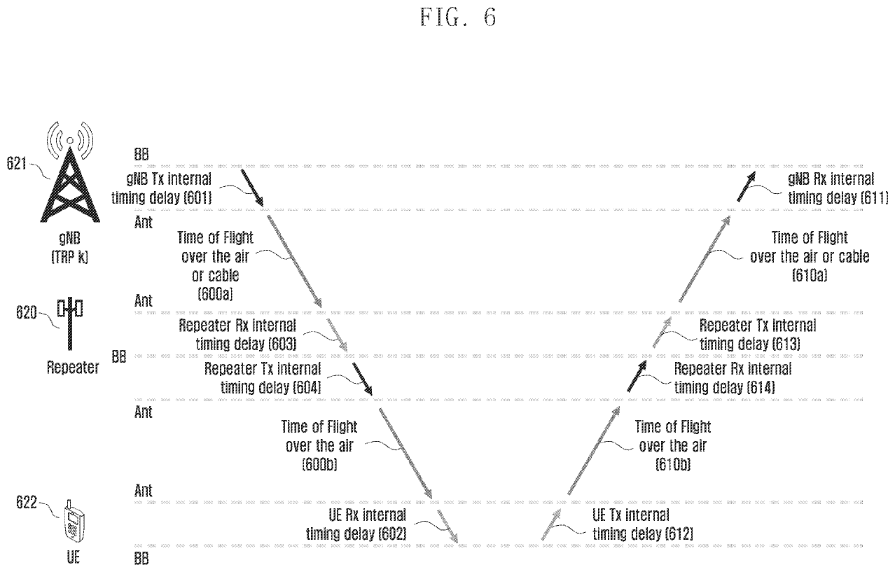

FIG. 6 is a diagram for describing a timing error and a TEG when a repeater is considered, according to an embodiment of the disclosure, For TEG, reference is made to the definition above.

Referring to FIG. 6, consideration is given to a positioning method in which, when a positioning signal transmitted by a base station 621 (which can be used interchangeably with TRP k) to a UE 622 is forwarded through a repeater 620, the UE 622 measures a time at which the signal has been transmitted. The equation below represents a time at which a positioning signal measured by the UE has been transmitted, when the positioning signal has been transmitted by the base station 621 and received by the UE 622 through the repeater 620.

t_{UE-measurement}=t_{k-UE(TOF)}+e_{delay}+e_{delay_repeater} [Equation 3]

In the equation above, t_{k-UE(TOF)} corresponds to 600a and 600b in FIG. 6, and denotes a time (ToF) at which the signal has actually been transmitted from the base station or TRP k 621 to the UE 622. e_{delay} denotes a timing error value, and a corresponding error may occur due to 601 and 602. Specifically, 601 is an internal delay that occurs when the base station 621 transmits a positioning signal, and may correspond to a delay time occurring from a point in time when the signal is generated in a BB to a point in time when the RF signal is transmitted through an antenna. In addition, 602 is an internal delay that occurs when the UE 622 receives the positioning signal, and may correspond to a delay time occurring when the RF signal received through an antenna reaches a baseband (BB) and is time-stamped. The base station 621 may provide, as TX TEG, an internal delay value (or a remaining delay time after correction) of the base station or TRP to a location server, the internal delay value corresponding to 601. In addition, the UE 622 may provide, as RX TEG, a value (or a remaining delay time after correction) corresponding to 602 to the location server.

In Equation 3, e_{delay_repeater} denotes a timing error value generated in the repeater 620, and a corresponding error may occur due to 603 and 604. Specifically, 603 is an internal delay that occurs when the repeater 620 receives the positioning signal, and may correspond to a delay time occurring when the RF signal received through an antenna reaches a baseband (BB) and is time-stamped. In addition, 604 is an internal delay that occurs when the repeater 620 transmits the positioning signal, and may correspond to a delay time occurring from a point in time when the signal is generated in the BB to a point in time when the RF signal is transmitted through the antenna. In the disclosure, a value corresponding to 603 or 604 (or a remaining delay time after correction) may be referred to as repeater TEG. However, this may also be referred to as another name representing an internal delay generated in the repeater. The value corresponding to 603 or 604 or the remaining delay time after correction may be a calculated value or a quantized value expressed in a specific time unit. Reference is made to the embodiments below for details on a method of compensating for an internal delay occurring in the repeater and the repeater TEG.

In addition, referring to FIG. 6, consideration is given to a positioning method in which, when the UE 622 transmits the positioning signal to the base station 621 through the repeater 620, the base station 621 measures a time at which the signal has been transmitted. The equation below represents a time at which a positioning signal measured by the base station has been transmitted, when the positioning signal has been transmitted by the UE 622, forwarded through the repeater 620, and received by the base station 621.

t_{BS-measurement}=t_{k-UE(TOF)}+e_{delay}+e_{delay_repeater} [Equation 4]

In the equation above, t_{k-UE(TOF)} corresponds to 610a and 610b in FIG. 6, and denotes a time (ToF) at which the signal has actually been transmitted from the UE 622 to the base station or TRP k 621. e_{delay} denotes a timing error value, and a corresponding error may occur due to 612 and 611. Specifically, 612 is an internal delay that occurs when the UE 622 transmits a positioning signal, and may correspond to a delay time occurring from a point in time when the signal is generated in the baseband (BB) to a point in time when the RF signal is transmitted through the antenna. In addition, 611 is an internal delay that occurs when the base station 621 receives the positioning signal, and may correspond to a delay time occurring when the RF signal received through the antenna reaches the baseband (BB) and is time-stamped. The UE 622 may provide, as TX TEG, a value (or a remaining delay time after correction) corresponding to 612 to the location server. In addition, the base station 621 may provide, as RX TEG, a value (or a remaining delay time after correction) corresponding to 611 to the location server, the value being an internal delay value of the base station and TRP.

In Equation 4, e_{delay_repeater} denotes a timing error value generated in the repeater 620, and a corresponding error may occur due to 614 and 613. Specifically, 614 is an internal delay that occurs when the repeater 620 receives the positioning signal, and may correspond to a delay time occurring when the RF signal received through the antenna reaches the baseband (BB) and is time-stamped. In addition, 613 is an internal delay that occurs when the repeater 620 transmits the positioning signal, and may correspond to a delay time occurring from a point in time when the signal is generated in the BB to a point in time when the RF signal is transmitted through the antenna. In the disclosure, a value corresponding to 614 or 613 (or a remaining delay time after correction) may be referred to as repeater TEG. However, this may also be referred to as another name representing an internal delay generated in the repeater. Reference is made to the embodiments below for details on a method of compensating for an internal delay occurring in the repeater and the repeater TEG.

The errors in measuring the internal delay times occurring during DL and UL transmission presented in FIG. 6 may also occur in the same manner when positioning is performed via SL if a repeater is considered.

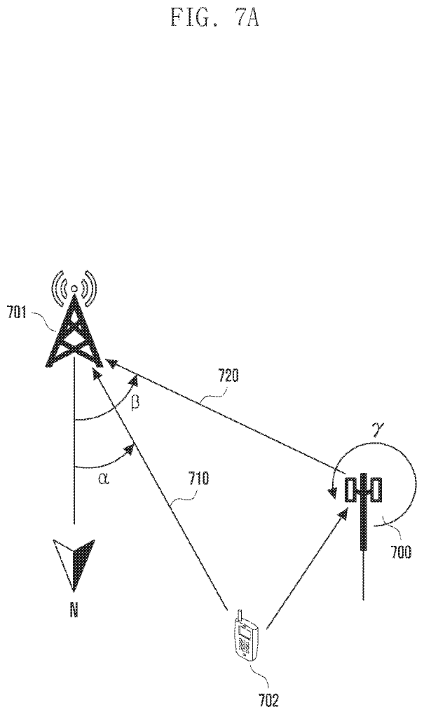

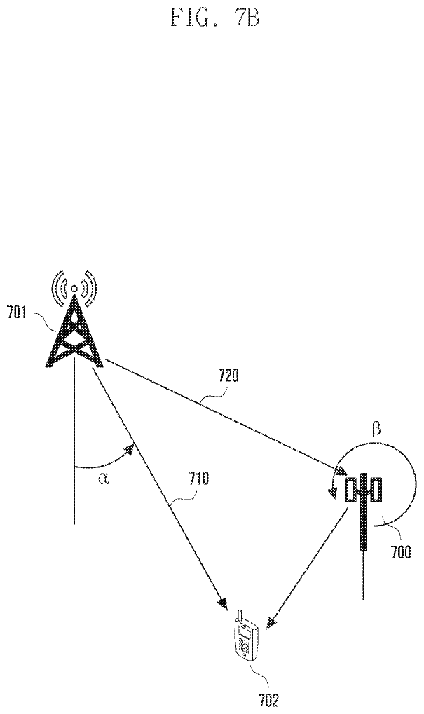

FIG. 7A is a diagram illustrating an example of the influence of a positioning method via angle measurement when a repeater is considered, according to an embodiment of the disclosure.

Referring to FIG. 7A, illustrated is a case in which a UE 702 transmits, as a UL signal, an SRS for positioning measurement to a base station 701, and the base station receives the signal and measures AoA. In the case of 710 where a signal of the UE 702 is directly transmitted to the base station 701, the AoA measured by the base station for UE positioning is measured as α. In contrast, in the case of 720 where a signal of the UE 702 is transmitted to the base station 701 through a repeater 700, the AoA measured by the base station for UE positioning is measured as β. Therefore, it is obvious that an error occurs in angle measurement for UE positioning.

FIG. 7B is a diagram illustrating another example of the influence of a positioning method via angle measurement when a repeater is considered, according to an embodiment of the disclosure.

Referring to FIG. 7B, illustrated is a case in which the base station 701 transmits, as a DL signal, a PRS for positioning measurement to the UE 702, and the base station measures AoD based on PRS reference signal received power (RSRP) information reported by the UE. In FIG. 7B, in the case of 710 where a signal of the base station 701 is directly transmitted to the UE 702, the UE reports the PRS RSRP information based on the signal received from the base station, and AoD estimated by the base station for UE positioning is measured as α. In contrast, in the case of 720 where a signal of the base station 701 is transmitted to the UE 702 through the repeater 700, the UE reports the PRS RSRP information based on the signal received from the repeater, and AoD estimated by the base station accordingly is measured as β. Therefore, it is obvious that an error occurs in angle measurement for UE positioning.

The angle measurement errors occurring due to the repeater during DL and UL transmission presented in FIG. 7A and FIG. 7B may also occur in the same manner when positioning is performed via SL if the repeater is considered.

The disclosure proposes methods to solve a problem in which an error occurs in time- and angle-based positioning measurement due to a repeater. One or more of the following embodiments may be combined with each other and used.

### First Embodiment

The first embodiment proposes a method capable of solving a problem, in which an error occurs in time-based positioning measurement due to a repeater, via base station implementation. However, the base station implementation method is not limited only to the method proposed in the embodiment. In addition, the method presented in the embodiment may not be able to solve a problem in which an error occurs in angle-based positioning measurement due to a repeater.

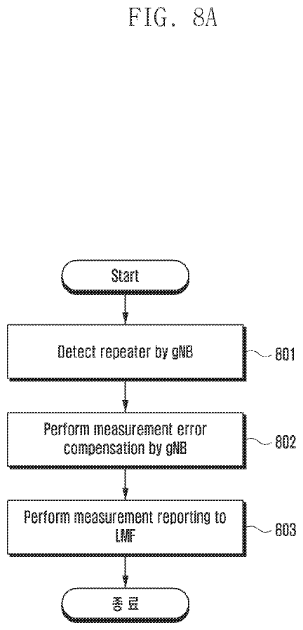

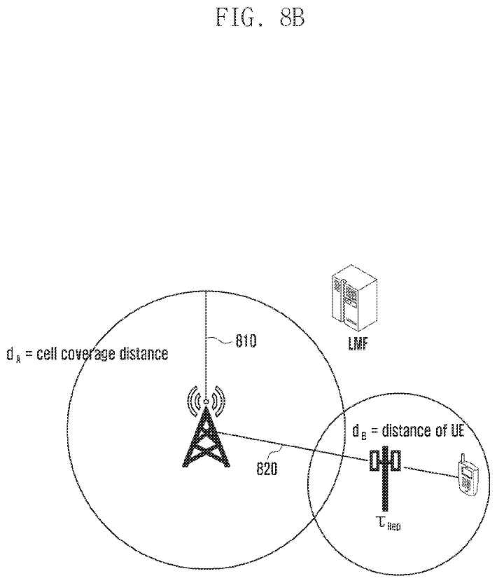

FIG. 8A is a diagram illustrating an example of a method for solving, via base station implementation, a problem in which an error occurs in time-based positioning measurement due to a repeater, according to an embodiment of the disclosure.

Referring to FIG. 8A, a base station may determine whether a signal transmitted from a UE is received through a repeater (operation 801). Subsequently, based on a result of operation 801, the base station may determine whether to compensate for an internal delay occurring in the repeater (operation 802). Specifically, if it is determined in operation 801 that the positioning signal transmitted from the UE has been received through the repeater, the base station may compensate for the internal delay. Here, the positioning signal transmitted from the UE may be an SRS.

The base station may compensate for a corresponding internal delay value in time-based positioning measurement. Referring to FIG. 6 and Equation 4, the base station may identify the internal delay value corresponding to each of 613 and 614 (the e_{delay_repeater} value in Equation 4) and remove the same. Here, the internal delay value is assumed to be known to the base station. If a network operator has installed the repeater to increase coverage while operating the base station, it may be assumed that the base station knows an approximate internal delay of the repeater. However, an internal delay value may not be a fixed value, and may be a value varying over time. In addition, if the repeater is not installed by an operator, it cannot be assumed that the base station knows an internal delay of the repeater. This problem can be solved using the method presented in the embodiment below. Subsequently, the base station may forward 803 positioning values measured via operations 801 and 802 to a location server (LMF), and the location server may calculate a location of the UE.

FIG. 8B is a diagram illustrating an example of a method for a base station to determine whether a signal transmitted from a terminal is received through a repeater.

Referring to FIG. 8B, it is first assumed that a base station knows cell coverage 810 that the base station is able to cover. Subsequently, the base station may calculate a distance 820 to a UE. 802 may be identified during an operation of determining timing advance (TA) in an initial access operation, and may also be identified during an operation of performing round-trip time (RTT) for positioning. Specifically, in the case of RTT, if the base station transmits a DL PRS to the UE, and the UE transmits an UL SRS, so that an RX-TX time difference is provided, the base station may calculate the distance between the base station and the UE via the RX-TX time difference. When the distance 820 between the base station and the UE is identified, the base station compares the distance 820 with the cell coverage distance 810 that the base station is able to cover. If the distance 820 between the base station and the UE>the cell coverage distance 810, the base station may determine that the signal transmitted by the UE is received through the repeater.

When the base station determines whether the signal transmitted by the UE is received through the repeater, additional parameters, such as RSRP or noise power of the positioning signal, may be used. Specifically, if the distance 820 between the base station and the UE>the cell coverage distance 810, and RSRP is large, it may be determined that the signal transmitted by the UE is highly likely to have been received through the repeater. This is because, in general, RSRP decreases as a distance between a base station and a UE increases, but when a repeater is used, the RSRP may increase. Here, the RSRP may be a value measured by the base station or a value provided by the UE. Similarly, if the distance 820 between the base station and the UE>the cell coverage distance 810, and both RSRP and measured noise power are large, it may be determined that the likelihood of the signal transmitted by the UE being received through the repeater is even higher. The noise power here is due to the fact that noise may also increase after the signal passes through the repeater.

However, results determined via the method described above may also be incorrect. For example, the repeater may be located within the base station coverage, and the coverage of the base station and the repeater may not be circular as illustrated in FIG. 8B. In particular, in the case of the repeater, signals may be radiated in only a specific direction depending on the antenna installed in the repeater and radiation characteristics.

### Second Embodiment

The second embodiment proposes a method capable of solving a problem, in which an error occurs in time- and angle-based positioning measurement due to a repeater, via standard support. However, the standard support method is not limited only to the method proposed in the embodiment.

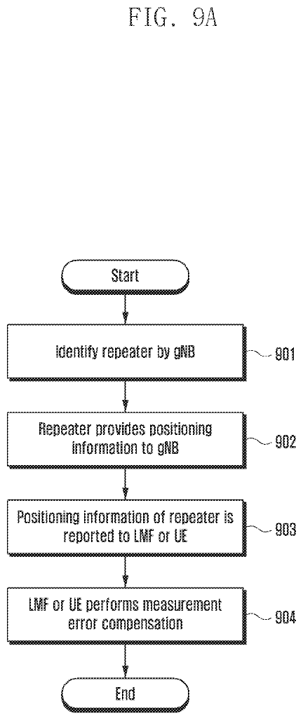

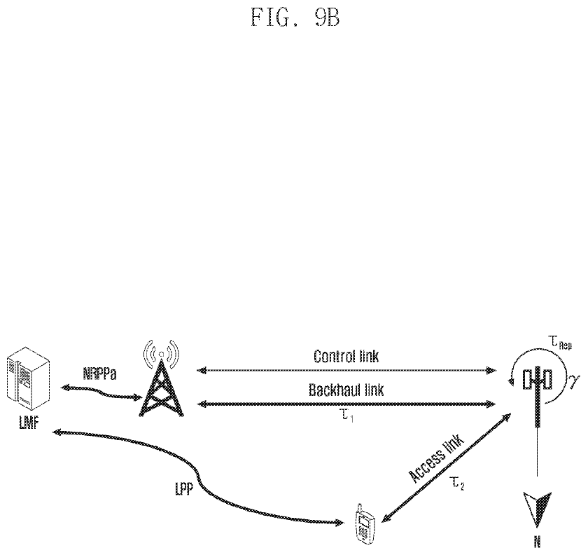

FIG. 9A is a diagram illustrating an example of a method capable of resolving, via standard support, a problem in which an error occurs in time- and angle-based positioning measurement due to a repeater, according to an embodiment of the disclosure.

Referring to FIG. 9A, a base station may identify a repeater (operation 901). In other words, the base station may distinguish whether a received signal has been transmitted from a repeater or from a regular UE (not a repeater). For example, if the repeater is an NCR, the base station may identify the repeater. In the case of an NCR, since the repeater is also recognized as a type of UE by the base station, the NCR performs an initial access to the base station, and during this procedure, the base station may identify whether the UE is an NCR. Therefore, after the initial access, when the base station receives a signal transmitted by the repeater, it may be possible for the base station to identify the repeater, as in operation 901.

Subsequently, the repeater may provide the base station with positioning-related information generated by the repeater (operation 902). In this case, the positioning-related information generated by the repeater may include at least one piece of the following information. However, the positioning-related information in the disclosure is not limited to the information below,
Internal delay information (τ_{Rep}) of the repeater
AoA information (γ) measured by the repeater
Antenna reference point (ARP) information at the time of measuring AoA by the repeater
Repeater coordinate location information
Information on a propagation time (τ₁) between the base station and the repeater, the propagation time being measured by the repeater

Reference is made to the detailed description of FIG. 6 for the internal delay information (τ_{Rep}) of the repeater in the information above. It has been described via the previous embodiment that the internal delay information of the repeater is a value that may vary over time.

The AoA information (γ) measured by the repeater is illustrated in FIG. 7A. In FIG. 7A, it has been described that, when the positioning signal transmitted by the UE reaches the base station via the repeater, an error occurs in angle measurement. Accordingly, the disclosure proposes a method of performing AoA measurement by a repeater and providing measurement information thereof to a base station. FIG. 7A illustrates a case in which the repeater measures AoA for a UL SRS signal received from the UE and measures a corresponding γ value. In operation 902, when AoA information (γ) measured by the repeater is provided to the base station, coordinate location information of the repeater and ARP information of the repeater at the time of AoA measurement may also be provided to the base station. Finally, information on the propagation delay (τ₁) between the base station and the repeater may be provided to the base station, the propagation delay being measured by the repeater. Details on this may be described via FIG. 9B.

Subsequently, the base station may report the positioning-related information at the repeater, which is identified in operation 902, to an LMF via NRPPa and/or provide the information to the UE (operation 903). In operation 903, for a method of providing the UE with the positioning-related information at the repeater, consideration may be given to a method in which the positioning-related information at the repeater is provided to the UE via LPP by an indication of the LMF, and/or to a method in which the base station directly provides the positioning-related information at the repeater to the UE via DL control information or data information. The base station may provide the positioning-related information to the UE via DCI as DL control information or via RRC signaling or MAC-CE as data information. The operation of providing the UE with the positioning-related information at the repeater may be performed in various ways. For example, when internal delay information of the repeater is provided, the internal delay information of the base station (and TRP) and the internal delay information of the repeater described in FIGS. 5 and 6 may be provided separately or together. In addition, the internal delay information of the repeater may be provided only when the UE is expected to receive a signal through the repeater, and the base station or the LMF (which can be used interchangeably with a location server) may indirectly indicate, using the information, to the UE whether the signal is received through the repeater, Whether the UE receives a signal through the repeater may be determined based on the method according to FIG. 8B or the determination in operation 902 regarding whether the base station receives a signal through the repeater. In addition, positioning-related information of another repeater may also be provided in a similar manner.

Finally, based on the information provided in operation 903, a problem in which an error occurs in time- and angle-based positioning measurement due to the repeater may be compensated as follows (operation 904). First, when location calculation of the UE is performed by the LMF, the LMF may compensate for time- and angle-based positioning errors occurring due to the repeater, based on the information provided in operation 903. Alternatively/additionally, the LMF may identify the location of the UE by using at least one of the positioning methods disclosed in the disclosure, based on the information provided in operation 903 (e.g., based on the location of the repeater and the location of the UE measured by the repeater). Alternatively, when location calculation of the UE is performed by the UE, the UE may compensate for time- and angle-based positioning errors occurring due to the repeater, based on the information provided in operation 903. Alternatively/additionally, the UE may identify its own location by using at least one of the positioning methods disclosed in the disclosure, based on the information provided in operation 903 (e.g., based on the location of the repeater and the location of the UE measured by the repeater).

In operation 903, a case in which the base station or the LMF provides the internal delay information of the repeater to the UE has been described. Two methods may be considered when the information is provided. A first UE operation is an operation of, based on the information, always compensating for an internal delay of the repeater when positioning measurement and UE location measurement are performed. In contrast, a second operation is an operation in which the UE determines whether to compensate for an internal delay of the repeater. This is because provided information cannot always be trusted. If the second method is used, the UE may consider a method of, when reporting positioning measurement information to the LMF, also providing information on whether compensation has been performed. The method of compensating for an internal delay of the repeater by the LMF in operation 904 may provide better positioning performance than the method of compensating for an internal delay of the repeater by the base station in operation 802 of FIG. 8A. This is because the LMF has more measurement candidate values, which provides a higher degree of freedom in determination of measurement candidates.

FIG. 9B is a diagram illustrating a more detailed example of a method of supporting a positioning method when a repeater is an NCR. According to FIG. 9B, a channel between a base station and a UE may not be line-of-sight (LOS) at least due to a repeater. When positioning is performed, positioning performance may be degraded in a nonline-of-sight (NLOS) channel. Accordingly, as illustrated in FIG. 9B, the channel between the base station and the UE may be divided into τ₁ and τ₂. Here, τ₁ is a propagation time between the base station and the repeater, and when the repeater is fixed, a corresponding value may be fixed and hardly change. In addition, τ₁ may be measured by the repeater. In contrast, τ₂ is a propagation time between the repeater and the UE, and a corresponding value may vary over time in consideration of the UE that generally moves. If the value of τ₁ is measured separately, only τ₂ needs to be considered during positioning measurement. Referring to FIG. 9B, when only τ₂ is separately considered, the channel may correspond to an LOS channel. In this case, Equation 4 may be replaced with the equation below by reflecting t_{UE-k(TOF)}=τ₁+τ₂. In addition, in Equation 5 below, positioning may be performed by calculating only a ToF corresponding to τ₂.

t_{BS-measurement}=τ₁+τ₂+e_{delay}+e_{delay_repeater} [Equation 5]

For descriptions of other parameters in the equation above, reference may be made to the description of Equation 4.

Subsequently, in FIG. 9B, the positioning-related information of the repeater described in operation 902 of FIG. 9A may be provided to the base station via a control link of FIG. 9B. A more detailed method of providing the positioning-related information of the repeater to the base station via the control link when a positioning signal is forwarded by the repeater via a backhaul link will be described via the following embodiment.

### Third Embodiment

The third embodiment proposes methods of transmitting information used to compensate for a positioning error occurring due to a repeater, based on the method presented in the second embodiment. Specifically, a more detailed method is presented for providing the positioning-related information of the repeater, which has been described in operation 902 of FIG. 9A, to the base station via the control link when a positioning signal is forwarded by the repeater via the backhaul link of FIG. 9B.

First, a point in time when the positioning-related information of the repeater, which has been described in operation 902 of FIG. 9A, needs to be provided to the base station may vary depending on related information. Since time-related internal delay information of the repeater, or information on a propagation time (τ₁) between the base station and the repeater, the propagation time being measured by the repeater, may not be information that frequently changes over time, it may not be necessary to provide the information every time positioning information is forwarded from the repeater to the base station. Coordinate location information of the repeater may also not need to be provided every time positioning information is forwarded from the repeater to the base station. However, since the location of the UE may vary over time, AoA information (γ) measured by the repeater and ARP information at the time of measuring AoA by the repeater, which are related to angles, may need to be provided every time positioning information is forwarded from the repeater to the base station.

In consideration of this, the following alternatives of providing the positioning-related information of the repeater to the base station via the control link of FIG. 9B may be considered. As described above, according to the positioning-related information of the repeater, an appropriate method among the alternatives presented below may be determined. It should be noted that the disclosure is not limited only to the alternatives below. It should also be noted that the alternatives below may combined and be used.
Alternative 1: When the base station or the location server requests positioning-related information from the repeater via the control link, the repeater may report the information to the base station via the control link. Alternatively/additionally, the repeater may be configured to periodically report the information to the base station via the control link.
Alternative 2: The base station or the location server provides information of the UE performing positioning to the repeater via the control link, and when the repeater forwards a positioning signal of the UE to the base station, the repeater may report positioning-related information of the repeater via the control link.

In alternative 1, the base station may request the positioning-related information from the repeater via DCI. In this case, the DCI may have a DCI format for NCR, and the format may include, for example, 1-bit information indicating the request. In addition, a field for requesting time-related information and a field for requesting angle-related information are distinguished so that the request may be indicated. When the request is made via DCI, the DCI may include resource allocation information to be used when the repeater reports related information via the control link. For example, a time offset value may be configured, and the repeater may be indicated to, after receiving the DCI, report the information to the base station after the time offset. In addition, a frequency resource allocation location for the report may also be indicated via the DCI. In alternative 1, a request or configuration method via not only DCI but also RRC or MAC-CE may be considered. In addition, when the location server requests positioning-related information from the repeater, the request may be made via the LPP protocol. In alternative 1, when the base station or the location server requests positioning-related information from the repeater, reporting of the information may be performed on a dedicated resource. In this case, whenever positioning information is forwarded from the repeater to the base station, the positioning signal via the backhaul link and reporting of the information via the control link may be simultaneously transmitted from the repeater to the base station.

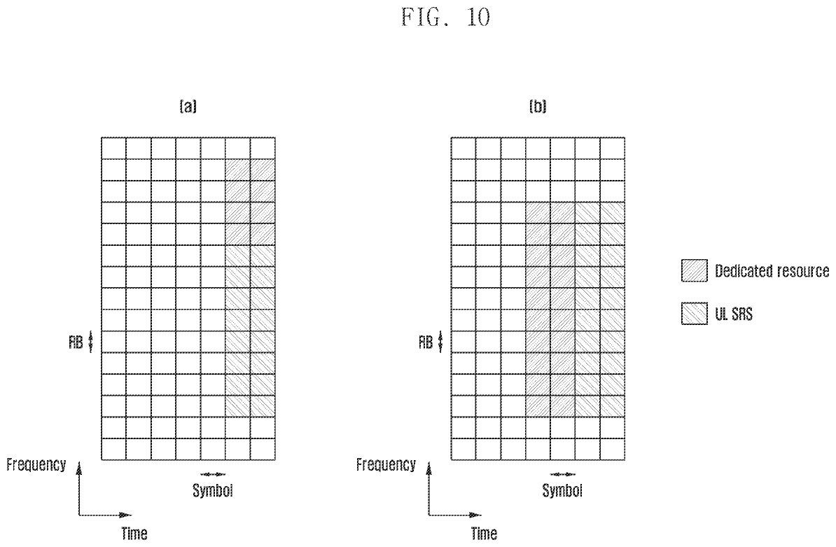

FIG. 10 is a diagram illustrating an example of a dedicated resource for requesting positioning-related information. As illustrated in FIG. 10A, positioning-related information and a UL SRS, i.e., a positioning signal, may be frequency-division multiplexed (FDMed) and simultaneously transmitted. In contrast, as illustrated in FIG. 10B, positioning-related information and a UL SRS, i.e., a positioning signal, may be time-division multiplexed (TDMed) and transmitted together.

In alternative 2, the UE information provided by the base station or the location server to the repeater may be cell-radio network temporary identifier (C-RNTI) information or SRS configuration information of the UE performing positioning. This information may be provided to the repeater via RRC signaling or MAC-CE. Alternatively, the UE information may be provided via a DCI format for NCR. When such information is provided, the repeater may be able to identify, using the information, a UL SRS transmission time of the UE performing positioning. In addition, at a point in time when the UE performing positioning transmits a UL SRS and the repeater forwards the UL SRS, positioning-related information of the repeater may be reported in a dedicated resource. In this case, whenever positioning information is forwarded from the repeater to the base station, a positioning signal via a backhaul link and reporting of the information via a control link may be simultaneously transmitted. For the dedicated resource, reference may be made to FIG. 10.

In addition, when the UE transmits a positioning signal to the base station, there may occur a case in which the base station receives both a signal directly transmitted without passing through the repeater and a signal received via the repeater. In this case, assuming NCR, the base station may be able to distinguish between the two signals. In this case, at least one combination of the following methods may be considered.
Method 1: The base station prioritizes a signal directly received from the UE, and performs positioning measurement
Method 2: The base station prioritizes a signal received through the repeater, and performs positioning measurement.
Method 3: The base station performs positioning measurement based on a signal with a larger RSRP among the two signals.
Method 4: The base station performs positioning measurement using one of the methods described above, and corrects a measured location by using another method.

In addition, the disclosure is not limited to the methods described above.

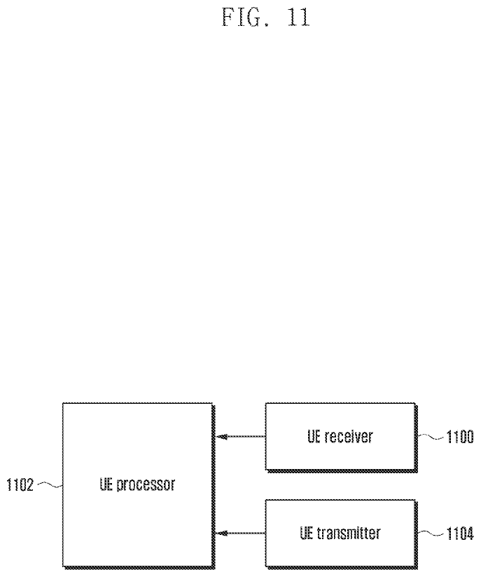

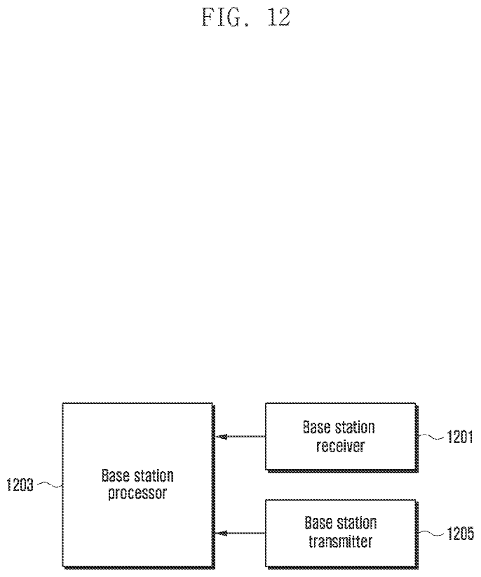

In order to perform the aforementioned embodiments of the disclosure, transmitters, receivers, and processors of a UE and a base station are illustrated in FIG. 11 and FIG. 12, respectively. In the embodiments above, a method for a UE to perform positioning is shown, and in order to perform the method, respective receivers, processors, and transmitters of a base station and a UE need to operate according to the embodiments.

FIG. 11 illustrates an internal structure of a UE according to an embodiment of the disclosure. As illustrated in FIG. 11, the UE of the disclosure may include a UE receiver 1100, a UE transmitter 1104, and a UE processor 1102. The UE receiver 1100 and the UE transmitter 1104 as a whole may be referred to as a transceiver. The transceiver may transmit/receive signals with base stations. The signals may include control information and data. To this end, the transceiver may include an RF transmitter configured to up-convert and amplify the frequency of transmitted signals, an RF receiver configured to low-noise-amplify received signals and down-convert the frequency thereof, and the like. In addition, the transceiver may receive signals through a radio channel, output the same to the UE processor 1102, and transmit signals output from the UE processor 1102 through the radio channel. The UE processor 1102 may control a series of processes such that the UE can operate according to the above-described embodiments of the disclosure,

FIG. 12 illustrates an internal structure of a base station according to an embodiment of the disclosure. As illustrated in FIG. 12, the base station of the disclosure may include a base station receiver 1201, a base station transmitter 1205, and a base station processor 1203. The base station receiver 1201 and the base station transmitter 1205 as a whole may be referred to as a transceiver. The transceiver may transmit/receive signals with UEs. The signals may include control information and data. To this end, the transceiver may include an RF transmitter configured to up-convert and amplify the frequency of transmitted signals, an RF receiver configured to low-noise-amplify received signals and down-convert the frequency thereof, and the like. In addition, the transceiver may receive signals through a radio channel, output the same to the base station processor 1203, and transmit signals output from the base station processor 1203 through the radio channel. The base station processor 1203 may control a series of processes such that the base station can operate according to the above-described embodiments of the disclosure.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, all the embodiment of the disclosure may be partially combined to operate a base station and a terminal.

1. A method performed by a terminal in a communication system, the method comprising:
receiving, from a base station, repeater-related information for positioning; and
identifying a location of the terminal, based on the repeater-related information,
wherein the location of the terminal is corrected based on the repeater-related information, and
wherein the repeater-related information is transmitted from a repeater to the base station.

2. The method of claim 1, wherein the repeater-related information comprises at least one of internal delay information of the repeater, an angle of arrival (AoA) measured by the repeater, information on an antenna reference point (ARP) during measurement of the AoA by the repeater, coordinate information associated with a location of the repeater, or information on a delay time between the base station and the repeater, measured by the repeater.

3. The method of claim 2, wherein the internal delay information of the repeater refers to an internal delay occurring in receiving and transmitting a positioning signal by the repeater.

4. The method of claim 1, wherein whether the repeater is used is identified based on at least one of a comparison between coverage of a cell associated with the base station and a distance between the terminal and the base station, a reference signal received power (RSRP) of the positioning signal, or a noise power.

5. A method performed by a base station in a communication system, the method comprising:
receiving, from a repeater, repeater-related information for positioning; and
transmitting, to a terminal, the received repeater-related information,
wherein a location of the terminal is identified by the terminal, and
wherein the location of the terminal is corrected based on the repeater-related information.

6. The method of claim 5, wherein the repeater-related information comprises at least one of internal delay information of the repeater, an angle of arrival (AoA) measured by the repeater, information on an antenna reference point (ARP) during measurement of the AoA by the repeater, coordinate information associated with a location of the repeater, or information on a delay time between the base station and the repeater, measured by the repeater.

7. The method of claim 6, wherein the internal delay information of the repeater refers to an internal delay occurring in receiving and transmitting a positioning signal by the repeater.

8. The method of claim 5, further comprising identifying whether the repeater is used, based on at least one of a comparison between coverage of a cell associated with the base station and a distance between the terminal and the base station, a reference signal received power (RSRP) of the positioning signal, or a noise power.

9. A terminal in a communication system, the terminal comprising:
a transceiver; and
a controller configured to
receive, from a base station, repeater-related information for positioning, and
identify a location of the terminal, based on the repeater-related information,
wherein the location of the terminal is corrected based on the repeater-related information, and
wherein the repeater-related information is transmitted from a repeater to the base station.

10. The terminal of claim 9, wherein the repeater-related information comprises at least one of internal delay information of the repeater, an angle of arrival (AoA) measured by the repeater, information on an antenna reference point (ARP) during measurement of the AoA by the repeater, coordinate information associated with a location of the repeater, or information on a delay time between the base station and the repeater, measured by the repeater.

11. The terminal of claim 10, wherein the internal delay information of the repeater refers to an internal delay occurring in receiving and transmitting a positioning signal by the repeater.

12. The terminal of claim 9, wherein whether the repeater is used is identified based on at least one of a comparison between coverage of a cell associated with the base station and a distance between the terminal and the base station, a reference signal received power (RSRP) of the positioning signal, or a noise power.

13. A base station in a communication system, the base station comprising:
a transceiver; and
a controller configured to
receive, from a repeater, repeater-related information for positioning, and
transmit, to a terminal, the received repeater-related information,
wherein a location of the terminal is identified by the terminal, and
wherein the location of the terminal is corrected based on the repeater-related information.

14. The base station of claim 13, wherein the repeater-related information comprises at least one of internal delay information of the repeater, an angle of arrival (AoA) measured by the repeater, information on an antenna reference point (ARP) during measurement of the AoA by the repeater, coordinate information associated with a location of the repeater, or information on a delay time between the base station and the repeater, the delay time being measured by the repeater, and
wherein the internal delay information of the repeater refers to an internal delay occurring in receiving and transmitting a positioning signal by the repeater.

15. The method of claim 13, wherein the controller is configured to identify whether the repeater is used, based on at least one of a comparison between coverage of a cell associated with the base station and a distance between the terminal and the base station, a reference signal received power (RSRP) of the positioning signal, or a noise power.
